(19) United States
(12) Patent Application Publication
(10) Pub. No.: US 2014/0211392 A1
(43) Pub. Date: Jul. 31, 2014

(54) ELECTRONIC DEVICE WITH KEYBOARD

(71) Applicant: HON HAI PRECISION INDUSTRY CO., LTD., New Taipei (TW)

(72) Inventor: CHIA-WEI TING, New Taipei (TW)

(73) Assignee: HON HAI PRECISION INDUSTRY CO., LTD., New Taipei (TW)

(21) Appl. No.: 14/154,940

(22) Filed: Jan. 14, 2014

(30) Foreign Application Priority Data
Jan. 25, 2013 (TW) 102102778

(51) Int. Cl. G06F 1/16

(52) U.S. Cl. CPC G06F 1/1662
USPC 361/679.09

(57) ABSTRACT

An electronic device includes a keyboard module and a cover. The cover defines a keyboard area. A support beam is located under the keyboard module. The support beam extends through the keyboard area. The support beam can replace present supporting board. Space under the keyboard module can be increased.

### BACKGROUND

1. Technical Field

The present disclosure relates to electronic devices, and particularly to an electronic device with a keyboard.

2. Description of Related Art

A supporting structure is generally secured to a bottom portion of a keyboard, especially a keyboard of a notebook, to prevent the keyboard from elastically deforming when the keyboard is tapped. Generally, the supporting structure is a supporting plate made of metal or plastic. However, the supporting plate occupies a substantial volume in the notebook chassis. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an electronic device.

FIG. 2 is an isometric view of a support beam of the electronic device of FIG. 1.

FIG. 3 is an assembled, isometric view of the electronic device of FIG. 1 viewed from a different aspect.

FIG. 4 is an enlarged view of a circled portion IV of FIG. 3.

FIG. 5 is a cross sectional view of the electronic device of FIG. 3, taken along a line V-V.

FIG. 6 is a cross sectional view of the support beam in a second embodiment.

FIG. 7 is a cross sectional view of the support beam in a third embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

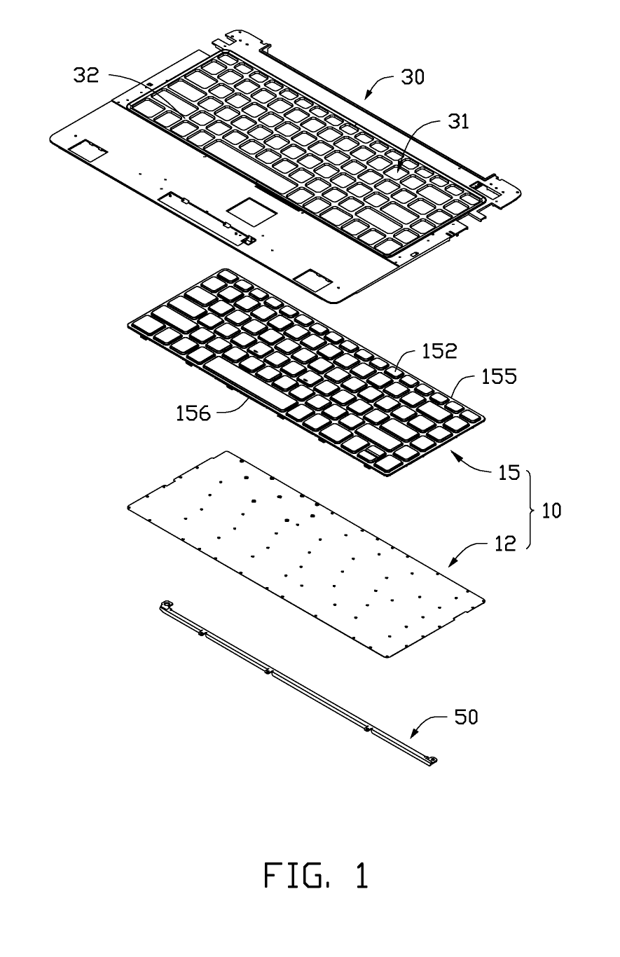

FIG. 1 shows one embodiment of an electronic device. The electronic device comprises a keyboard module 10, a cover 30, and a support beam 50. The electronic device may be notebook computer, for example.

The keyboard module 10 can comprise a keyboard plate 15 and a base plate 12 adhered to a bottom surface of the keyboard plate 15. The keyboard plate 15 comprises a plurality of keycaps 152. The keyboard plate 15 is substantially rectangular and comprises a top edge 155 and a bottom edge 156. The top edge 155 and the bottom edge 156 are two long edges of the keyboard plate 15. The base plate 12 comprises a plurality of touch switches (not shown) corresponding to the plurality of keycaps 152. The keyboard module 10 may be a membrane keyboard module, for example.

The cover 30 defines a keyboard area 31. The keyboard area 31 is substantially rectangular and comprises a frame 32 located in the keyboard area 31.

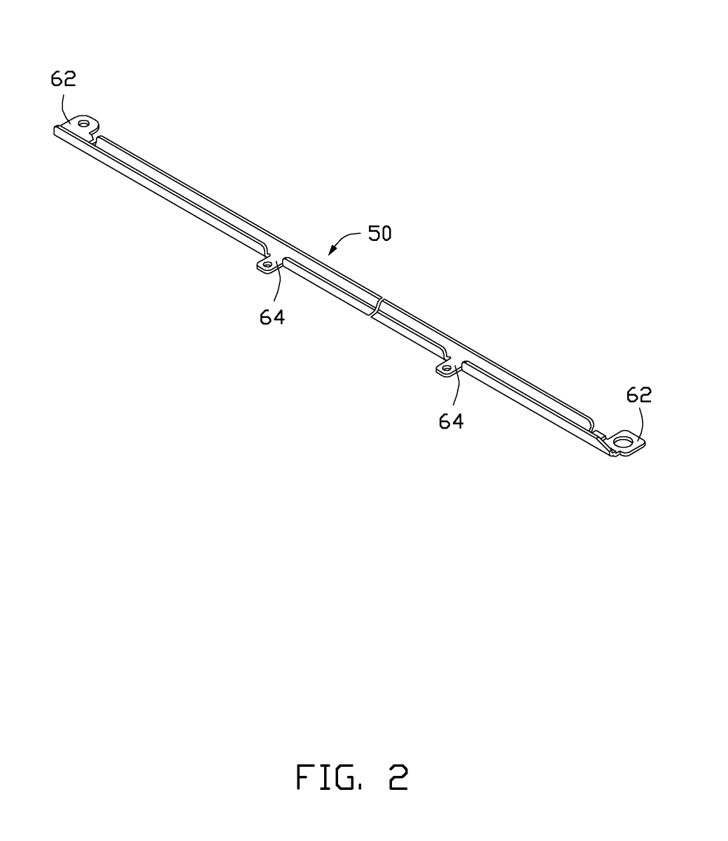

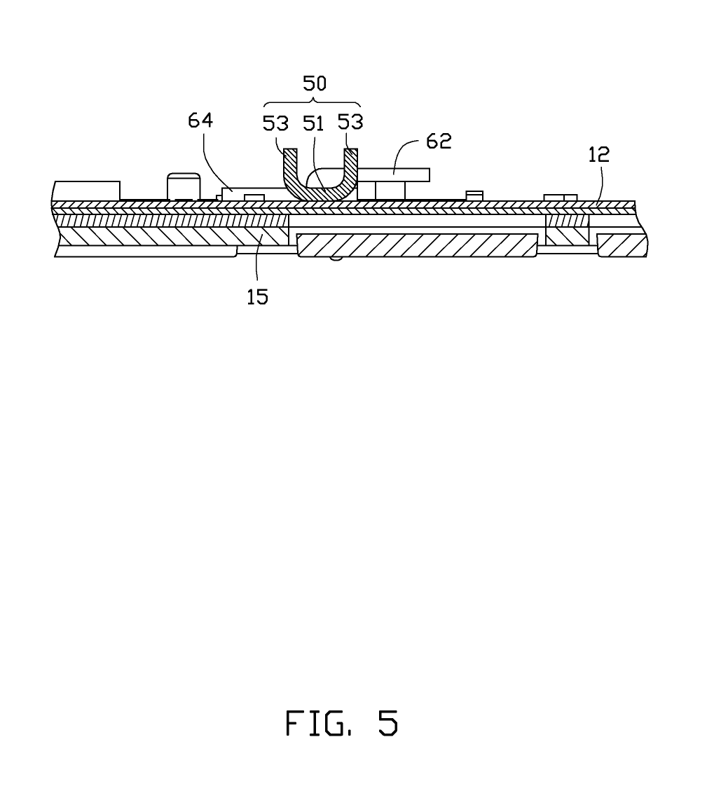

FIGS. 2 and 5 show that a cross section of the support beam 50 is a curved structure. In one embodiment, the support beam 50 extends straight, and the cross section of the support beam 50 is “U” shaped. The support beam 50 comprises a supporting piece 51 and two flanges 53 extending from opposite edges of the supporting piece 51. A first mounting portion 62 extends from each end of the support beam 50. A plurality of second mounting portions 64 is located between the first mounting portions 62 and extend from the support beam 50 in the opposite direction of the first mounting portions 62.

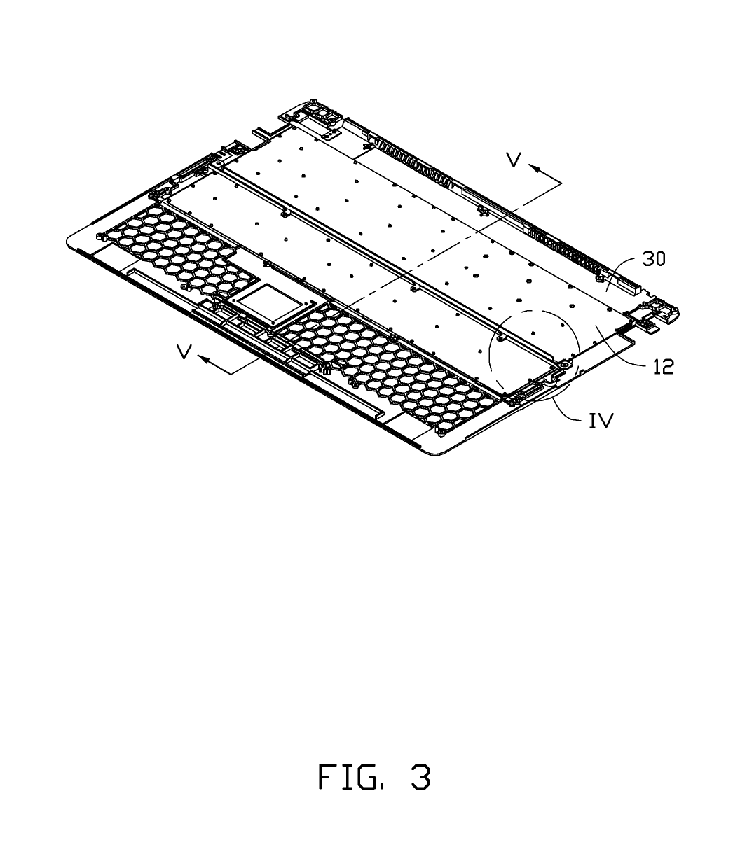

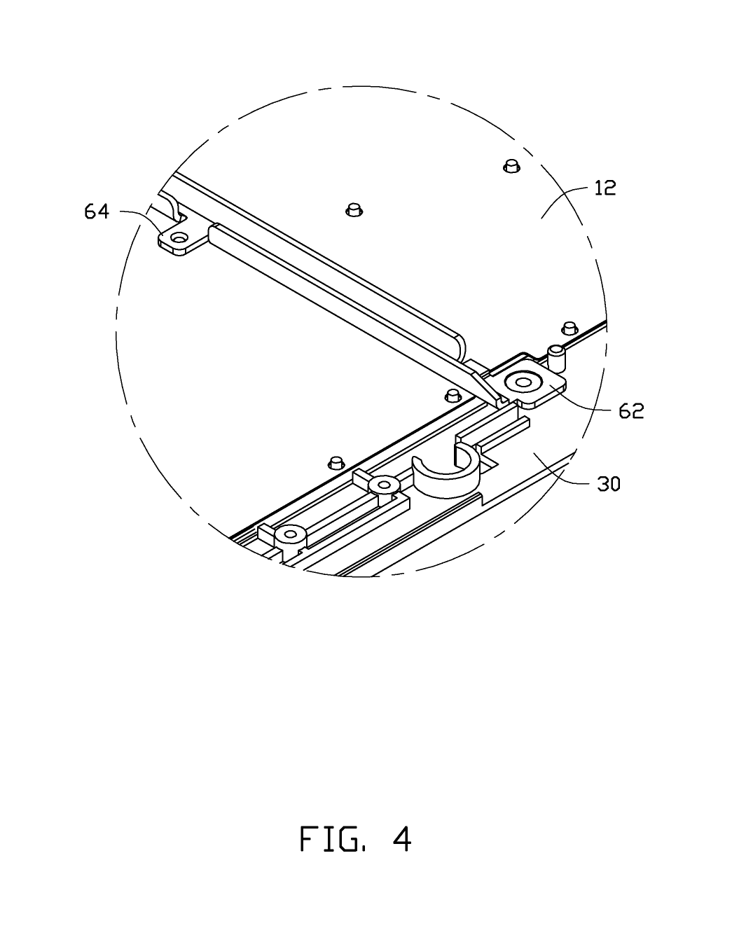

FIGS. 3-5 show that in assembly, the keyboard module 10 is received in the keyboard area 31. The first mounting portion 62 extends outside of the base board 12. The first mounting portion 62 is secured to the frame 32 by screws or other securing methods. The second mounting portions 64 are secured to the frame 32 through the base board 12. The support beam 50 is substantially parallel to the top edge 155 and the bottom edge 156 of the keyboard plate 15. The supporting piece 51 abuts the base board 12. The flanges 53 extend away from the keyboard module 10. Thus, the support beam 50 supports the keyboard module 10.

In the illustrated embodiment, the installation position of the support beam 50 can be adjusted as required. For example, if the plurality of keyboard caps 152 is adjacent to the bottom edge 156, a distance between the support beam 50 and the bottom edge 156 is smaller than a distance between the support beam 50 and the top edge 155.

In other embodiments, the support beam 50 can be secured to the top edge 155 or the bottom edge 156. The support beam 50 can be slanted relative to the top edge 155 and the bottom edge 156. The support beam 50 can define a curved structure.

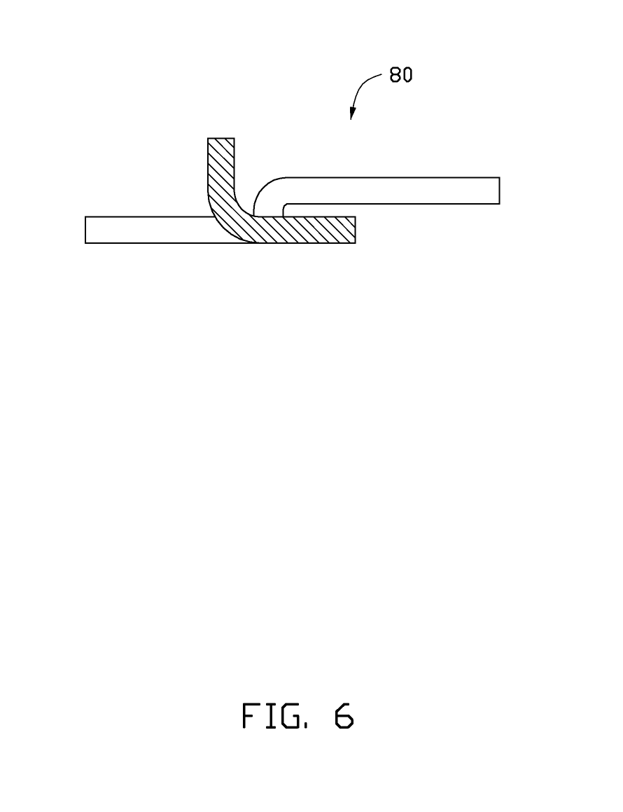

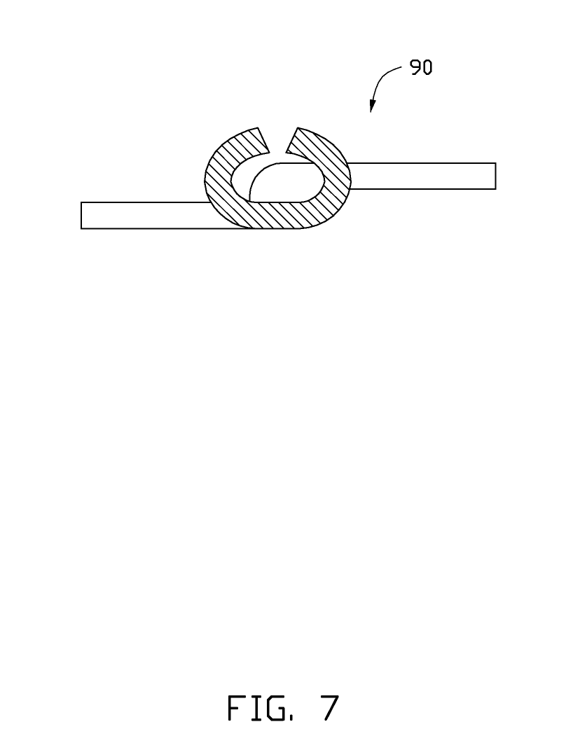

FIGS. 6-7 show that in other embodiments, a cross section of the support beam 80, 90 can be other curved structures, such as “L” shaped, “D” shaped, and waved.

The number of the support beams 50 can be two or more to add strength to the keyboard module 10. The two or more supporting beams 50 can be substantially parallel to each other to support the keyboard module 10 cooperatively.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. An electronic device, comprising:
a cover defining a keyboard area;
a keyboard module received in the keyboard area; and
a support beam located under the keyboard module extending across the keyboard area and supporting the keyboard module.

2. The electronic device of claim 1, wherein the support beam extends substantially straight.

3. The electronic device of claim 2, wherein the keyboard module comprises a rectangular keyboard plate having two long edges, and the support beam is substantially parallel to the two long edges.

4. The electronic device of claim 3, wherein each opposite end of the support beam is secured to the cover.

5. The electronic device of claim 4, wherein the cover comprises a frame located in the keyboard area, and the support beam is secured to the frame.

6. The electronic device of claim 5, wherein a first mounting portion extends from the each opposite end of the supporting beam.

7. The electronic device of claim 3, wherein a distance between the support beam and one of the two long edges is different from a distance between the support beam and the other of the two long edges.

8. The electronic device of claim 1, wherein a cross section of the support beam is a curved structure.

9. The electronic device of claim 8, wherein the cross section of the support beam is “U” shaped.

10. The electronic device of claim 8, wherein the support beam comprises a supporting piece and two flanges extending from the supporting piece, the supporting piece abuts the keyboard module, and the two flanges extend away from the keyboard module.

11. An electronic device, comprising:
a cover defining a keyboard area;
a keyboard module received in the keyboard area and comprising a keyboard plate and a base plate adhered to a bottom surface of the keyboard plate; and
a support beam located under the keyboard module extending across the keyboard area and comprising a curved structure abutting the base plate.

12. The electronic device of claim 11, wherein the support beam extends substantially straight.

13. The electronic device of claim 12, wherein the keyboard module comprises a rectangular keyboard plate having two long edges, and the support beam is substantially parallel to the two long edges.

14. The electronic device of claim 13, wherein each opposite end of the support beam is secured to the cover.

15. The electronic device of claim 14, wherein the cover comprises a frame located in the keyboard area, and the support beam is secured to the frame.

16. The electronic device of claim 15, wherein a first mounting portion extends from the each opposite end of the supporting beam.

17. The electronic device of claim 13, wherein a distance between the support beam and one of the two long edges is different from a distance between the support beam and the other of the two long edges.

18. The electronic device of claim 11, wherein a cross section of the support beam is “U” shaped.

19. The electronic device of claim 18, wherein the support beam comprises a supporting piece and two flanges extending from the supporting piece, the supporting piece abuts the base plate, and the two flanges extend away from the base plate.

20. The electronic device of claim 11, wherein a first mounting portion and a second mounting portion extend from the support beam in two opposite directions, and the first mounting portion and the second mounting portion secure the support beam to the cover.
